(19) United States
(12) Patent Application Publication
(10) Pub. No.: US 2012/0149816 A1
(43) Pub. Date: Jun. 14, 2012

(54) Eco-Friendly Polyamide Resin Composition Having Flame Retardancy

(75) Inventors: Eun Joo LEE, Uiwang-si (KR); In Sik SIM, Uiwang-si (KR); Jong Cheol LIM, Uiwang-si (KR)

(73) Assignee: CHEIL INDUSTRIES INC., Gumi-si (KR)

(21) Appl. No.: 13/249,920

(22) Filed: Sep. 30, 2011

(30) Foreign Application Priority Data
Dec. 10, 2010 (KR) 10-2010-0126317

(51) Int. Cl. C08K 13/02; C08L 77/00; C08K 13/04; C08L 81/04

(52) U.S. Cl. 524/133

(57) ABSTRACT

A flame retardant thermoplastic resin composition includes (A) about 20 to about 99.49 wt % of an aromatic polyamide resin; (B) 0 to about 50 wt % of a polyphenylene sulfide resin; (C) about 0.5 to about 30 wt % of a phosphinic acid metal salt flame retardant; (D) about 0.01 to about 10 wt % of a zinc compound; and (E) 0 to about 70 wt % of a filler comprising an organic filler, an inorganic filler, or a combination thereof. The flame retardant thermoplastic resin composition can have excellent heat resistance, mechanical strength and processability, a low moisture absorption rate and can inhibit corrosion of a metal surface of an extruder or a mold. The flame retardant thermoplastic resin composition can be used for various electrical electronic parts or auto parts as an environmentally friendly flame retardant thermoplastic resin composition.

### CROSS-REFERENCE TO RELATED APPLICATIONS

This application claims priority under 35 USC Section 119 to and the benefit of Korea Patent Application No. 10-2010-0126317 filed on Dec. 10, 2010 in the Korean Intellectual Property Office, the disclosure of which is incorporated herein by reference in its entirety.

### FIELD OF THE INVENTION

The present invention relates to a flame retardant thermoplastic resin composition.

### BACKGROUND OF THE INVENTION

There is an increasing need for thermoplastic resins with high heat resistance and chemical resistance for use in electronic device parts, auto device parts, chemical device parts, and the like. An aromatic polyamide resin can have these characteristics but has poor flame retardancy. Accordingly, such resins can require a halogen-based flame retardant to satisfy the V-O rating according to the VB standards of UL-94.

However, recent restrictions on harmful materials such as the Restriction of Hazardous Substances Directive (ROHS) and the Prohibition on Certain Hazardous Substances in Consumer Products (POHS) have limited the use of halogen-based compounds in electronic/electric device parts.

U.S. Patent Publication No. 2007-0054992 is directed to a polyamide resin composition including a non-halogen-based flame retardant. However, physical properties of the composition, such as heat resistance and the like, can deteriorate because large amounts of flame retardant are required to provide V-O flame retardancy. In addition, since the composition is manufactured at a high temperature, it discharges a large amount of gas due to decomposition of the flame retardant. The composition can also corrode metal surfaces such as those found in molding machines, molds, and other polymer processing equipment.

### SUMMARY OF THE INVENTION

The present inventors have developed a polyamide resin composition that can have a a reduced amount of flame retardant. In the invention, a polyphenylene sulfide-based resin can be introduced as a part of the polyamide resin composition.

Since polyphenylene sulfide-based thermoplastic resin can have heat resistance, dimensional stability, chemical resistivity, flame retardancy, processability, and the like, it has been used as a replacement for metal materials in precision parts such as optical parts and electrical electronic parts. When polyphenylene sulfide-based resin is added to the polyamide resin composition of the present invention, the amount of flame retardant may be reduced. This can help reduce corrosion of metal surfaces found in polymer processing equipment, such as molding machines and molds, by decreasing the amount of out-gas discharge resulting from degradation of the flame retardant at high temperatures, for example, at the time of injection molding. However, there is still the problem that the polyamide resin composition does not maintain physical properties such as the inherent fluidity of polyamide resin.

Accordingly, in exemplary embodiments of the invention, the polyamide resin composition can further include an agent selected to minimize or prevent loss of other physical properties such as fluidity.

An exemplary embodiment of the present invention provides a flame retardant thermoplastic resin composition that can have excellent heat resistance, low moisture absorption rate and environmentally friendly flame retardancy.

Another embodiment of the present invention provides a flame retardant thermoplastic resin composition that can have small amount of out-gas discharge and excellent formability upon injection molding.

Another embodiment of the present invention provides a flame retardant thermoplastic resin composition which can inhibit corrosion of surfaces found in polymer processing equipment, such as a surface of a molding machine and/or a mold, yet also can maintain mechanical strength and fluidity of polyamide resin.

Another embodiment of the present invention provides a molded product produced using the flame retardant thermoplastic resin composition.

The flame retardant thermoplastic resin composition can have excellent heat resistance, mechanical strength and processability, a low moisture absorption rate, and excellent corrosion inhibition of metals, such as a metal surface of an extruder and/or a mold. Thus it may be used in the production of various electrical electronic parts and auto parts. For example, exemplary embodiments of the present invention include surface-mounted electronic parts made using the flame retardant thermoplastic resin composition.

Hereinafter, the present invention is illustrated in more detail with reference to examples. However, these are exemplary embodiments of the present invention only and are not limiting.

To achieve the above purposes, a flame retardant thermoplastic resin composition is provided that includes: (A) about 20 to about 99.49 wt % of an aromatic polyamide resin; (B) 0 to about 50 wt % of a polyphenylene sulfide resin; (C) about 0.5 to about 30 wt % of a phosphinic acid metal salt flame retardant; (D) about 0.01 to about 10 wt % of a zinc compound; and (E) about 0 to about 70 wt % of filler comprising an organic filler, an inorganic filler or a combination thereof, wherein the amounts of each of (A), (B), (C), (D), and (E) are based on about 100 wt % (the total weight) of (A), (B), (C), (D), and (E).

The present invention also provides a molded product produced from the flame retardant thermoplastic resin composition.

A flame retardant thermoplastic resin composition according to the present invention may be used in the production of various electrical electronic parts or auto parts as an environmentally friendly flame retardant thermoplastic resin composition because it can have excellent heat resistance, low moisture absorption rate, corrosion inhibition effect and mechanical strength, can reduce out-gas discharge upon injection molding to provide excellent processability, and can maintain fluidity.

### DETAILED DESCRIPTION OF THE INVENTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

Unless stated otherwise herein, the term “alkyl” refers to C1 to C14 alkyl, the term “alkoxy” refers to C1 to C14 alkoxy, the term “cyclic alkyl” refers to C3 to C20 cyclic alkyl, the term “alkylene” refers to C1 to C10 alkylene, the term “aryl” refers to C6 to C20 aryl, and the term “arylene” refers to C6 to C10 arylene.

The flame retardant thermoplastic resin composition includes (A) about 20 to about 99.49 wt % of an aromatic polyamide resin; (B) 0 to about 50 wt % of a polyphenylene sulfide resin; (C) about 0.5 to about 30 wt % of a phosphinic acid metal salt flame retardant; (D) about 0.01 to about 10 wt % of a zinc compound; and (E) about 0 to about 70 wt % of filler comprising organic filler, inorganic filler or a combination thereof.

Exemplary components included in the flame retardant thermoplastic resin composition according to the embodiments of the present invention will hereinafter be described in detail. However, these embodiments are only exemplary, and the present invention is not limited thereto.

(A) Aromatic Polyamide Resin

A polyamide resin is a polyamide comprising an amino acid and a lactam, or a diamine, and dicarboxylic acid as a main component.

Non-limiting examples of the main component include amino acids such as 6-aminocaproic acid, 11-aminoundecanoic acid, 12-aminododecanoic acid, para-aminomethyl benzoic acid, and the like; lactams such as ε-caprolactam, ω-laurolactam, and the like; aliphatic, alicyclic, and/or aromatic diamines such as tetramethylenediamine, hexamethylenediamine, 2-methylpentamethylenediamine, nonamethylenediamine undecamethylenediamine, dodecamethylenediamine, 2,2,4-/2,4,4-trimethylhexamethylenediamine, 5-methylnonamethylenediamine, metaxylenediamine, paraxylenediamine, 1,3-bis(aminomethyl)cyclohexane, 1,4-bis(aminomethyl)cyclohexane, 1-amino-3-aminomethyl-3,5,5-trimethylcyclohexane, bis(4-aminocyclohexyl)methane, bis(3-methyl-4-aminocyclohexyl)methane, 2,2-bis(4-aminocyclohexyl)propane, bis(aminopropyl)piperazine, aminoethylpiperazine, and the like; and aliphatic, alicyclic, and/or aromatic dicarboxylic acids such as adipic acid, suberic acid, azelaic acid, sebacic acid, dodecane diacid, terephthalic acid, isophthalic acid, 2-chloroterephthalic acid, 2-methylterephthalic acid, 5-methylisophthalic acid, 5-sodiumsulfoisophthalic acid, 2,6-naphthalenedicarboxylic acid, hexahydroterephthalic acid, hexahydroisophthalic acid, and the like. These materials can be used singly or in combination of two or more to provide a polyamide homopolymer or a copolymer.

According to one embodiment of the present invention, the aromatic polyamide resin may be produced by polycondensing dicarboxylic acid including about 10 to about 100 mol % of an aromatic dicarboxylic acid and an aliphatic diamine, alicyclic diamine, or a combination thereof.

Exemplary aromatic dicarboxylic acids may include without limitation terephthalic acid (TPA) represented by the following Chemical Formula 1, isophthalic acid (IPA) represented by the following Chemical Formula 2, or a combination thereof.

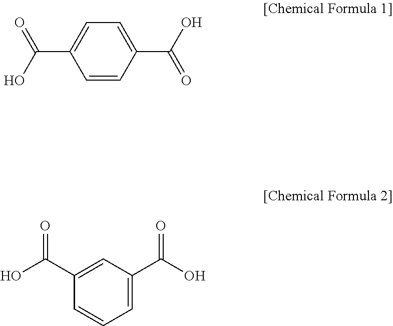

The aliphatic and/or alicyclic diamine may be represented by NRR′, wherein R and R′ are each independently H or substituted or non-substituted C4-C20 alkyl. As used herein, unless otherwise defined, the term “substituted” refers to a group in which a hydrogen is substituted with halogen (F, Cl, Br, I), hydroxy, nitro, cyano, amino, carboxyl, C1 to C20 alkyl, C2 to C20 alkenyl, C2 to C20 alkynyl, C1 to C20 alkoxy, C6 to C30 aryl, C6 to C30 aryloxy, C3 to C30 cycloalkyl, C3 to C30 cycloalkenyl, C3 to C30 cycloalkynyl, or a combination thereof.

A non-limiting example of an aliphatic and/or alicyclic diamine is hexamethylenediamine.

An exemplary aromatic polyamide resin according to one embodiment of the present invention can be a compound including benzene rings in a main chain, and having a melting point of about 180° C. or more. A non-limiting example of such an aromatic polyamide resin may be produced by polycondensing hexamethylene diamine and terephthalic acid and is called PA 6T, and also includes a repeating unit represented by the following Chemical Formula 3.

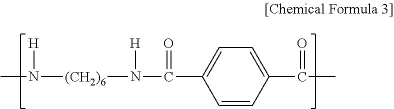

Other non-limiting examples of the aromatic polyamide resin include polytetramethylene adipamide (PA 46), polycaproamide/polyhexamethylene terephthalamide copolymer (PA6/6T), polyhexamethylene adipamide/polyhexamethylene terephthalamide copolymer (PA66/6T), polyhexamethylene adipamide/polyhexamethylene isophthalamide copolymer (PA66/6I), polyhexamethylene terephthalamide/polyhexamethylene isophthalamide copolymer (PA6T/6I), polyhexamethylene terephthalamide/polydodecaneamide copolymer (PA6T/12), polyhexamethylene adipamide/polyhexamethylene terephthalamide/polyhexamethylene isophthalamide copolymers (pA66/6T/6I), polyxylene adipamide (PA MXD6), polyhexamethylene terephthalamide/poly 2-methylpentamethylene terephthalamide copolymers (PA 6T/M5T), polynonamethylene terephthalamide (PA 9T), and the like, and combinations thereof.

According to another embodiment of the present invention, the aromatic polyamide resin may be prepared by adding an aliphatic polyamide resin to the aromatic polyamide resin. The mixed resin including the aromatic polyamide resin and the aliphatic polyamide resin may include an aliphatic polyamide resin in an amount of about 5 wt % to about 50 wt % based on the total amount of the mixed resin including the aromatic polyamide resin and the aliphatic polyamide resin. When the aliphatic polyamide is included in an amount within this range, it can lower manufacturing temperatures.

Non-limiting examples of the aliphatic polyamide resin may include PA6, PA66, and the like, and combinations thereof.

The flame retardant thermoplastic resin composition can include the aromatic polyamide resin (A) in an amount of about 20 to about 99.49 wt %, based on about 100 wt % (the total weight) of components (A), (B), (C), (D), and (E) as described herein. In some embodiments, the flame retardant thermoplastic resin composition may include the aromatic polyamide resin (A) in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.1, 99.2, 99.3, 99.4, or 99.49 wt %. Further, according to some embodiments of the present invention, the amount of the aromatic polyamide resin (A) can be in a range from about any of the foregoing amounts to about any other of the foregoing amounts.

When the flame retardant thermoplastic resin composition includes the aromatic polyamide resin in an amount within the above range, it can provide excellent mechanical properties, heat resistance, and formability.

(B) Polyphenylene Sulfide Resin

The polyphenylene sulfide resin according to one embodiment of the present invention may include a repeating unit represented by the following Chemical Formula 4 in an amount of about 70 mol % or more. When the repeating unit is included in an amount of about 70 mol % or more, the polyphenylene sulfide resin can have high crystallinity which is a feature of a crystalline polymer, and excellent heat resistance, chemical resistance, and strength.

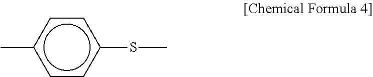

The polyphenylene sulfide resin may further include a repeating unit represented by one or more of the following Chemical Formulae 5 to 12 in addition to a repeating unit represented by the above Chemical Formula 4.

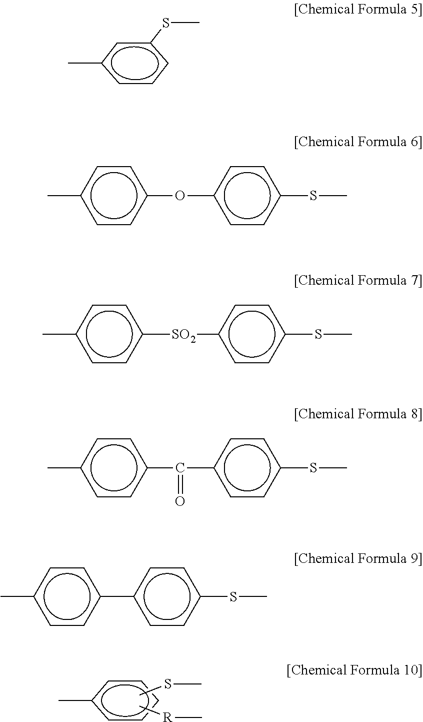

In the above Chemical Formula 10, R is C1-C20 alkyl, nitro, phenyl, C1-C20 alkoxy, carboxyl, or carboxylate group.

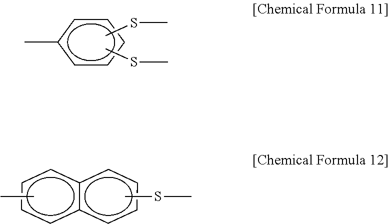

The polyphenylene sulfide resin can include a repeating unit represented by one or more of the above Chemical Formulae 5 to 12 in an amount of about 50 mol % or less, for example about 30 mol % or less. When the polyphenylene sulfide resin includes a repeating unit represented by one or more of the above Chemical Formulae 5 to 12 in an amount of about 50 mol % or more, the composition may have lower heat resistance and mechanical properties which are required.

Polyphenylene sulfide resin can have a linear molecule structure with no branched or cross-linked structures or a linear molecule structure with branched or cross-linked structures, depending on the manufacturing methods used to produce the same. However, as shown in the above Chemical Formula 4 to 12, the polyphenylene sulfide resin used in the present invention can include either a branched or cross-linked structure.

Japanese Patent Laid-Open Publication Soh No. 1970-3368 discloses a representative method of manufacturing a cross-linked polyphenylene sulfide resin. Japanese Patent Laid-Open Publication Soh No. 1977-12240 discloses a representative method of manufacturing a linear polyphenylene sulfide resin.

The polyphenylene sulfide resin may have a melting index (MI) of about 10 to about 300 g/10 minutes under a weight of about 2.16 kg at about 316° C., taking into consideration thermal stability or workability. When the polyphenylene sulfide resin has a melting index within the above range, it can have excellent kneading properties and excellent workability during molding processes with no strength deterioration.

The flame retardant thermoplastic resin composition can include the polyphenylene sulfide resin in an amount of 0 to about 50 wt % based on about 100 wt % (the total weight) of (A), (B), (C), (D), and (E). In some embodiments, the flame retardant thermoplastic resin composition may include the polyphenylene sulfide resin (B) in an amount of 0 wt % (that is, the polyphenylene sulfide resin is not present), or about 0 (that is, an amount greater than zero), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the polyphenylene sulfide resin (B) can be in a range from about any of the foregoing amounts to about any other of the foregoing amounts.

When the flame retardant thermoplastic resin composition includes the polyphenylene sulfide resin in an amount within the above range, the flame retardant thermoplastic resin composition can have excellent mechanical properties, heat resistance, and formability. By using the polyphenylene sulfide resin having flame retardancy as a basic resin, the content of the phosphinic acid metal salt below as a flame retardant can be minimized.

(C) Phosphinic Acid Metal Salt Flame Retardant

The phosphinic acid metal salt compounds used in the present invention can be represented by the following Chemical Formula 13, Chemical Formula 14, or a combination thereof.

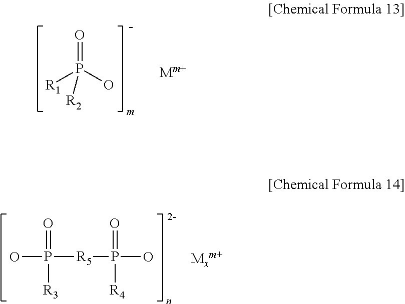

In the above Chemical Formulae 13 and 14,

each R₁ to R₄ is the same or different and is independently linear or branched C1 to C6 alkyl, C3 to C20 cyclic alkyl, or C3 to C10 aryl, for example methyl, ethyl, propyl, isopropyl, butyl, pentyl, or phenyl,

R₅ is C1 to C10 alkylene, C6 to C10 arylene, alkylarylene or arylalkylene, for example methylene, ethylene, propylene, butylene, pentylene, octylene, dodecylene, phenylene, naphthalene, methyl phenylene, ethyl phenylene, butyl phenylene, methyl naphthylene, ethyl naphthylene, butyl naphthylene, phenyl methylene, phenyl ethylene, phenyl propylene, or phenyl butylene,

M is a metal comprising Al, Zn, Ca or Mg, such as Al or Zn,

m is 2 or 3,

n is 1 or 3, and

x is 1 or 2.

Examples of the phosphinic acid metal salt compound according to the present invention can include without limitation aluminum diethylphosphinate, aluminum methylethylphosphinate, and the like, and combinations thereof.

The flame retardant thermoplastic resin composition of the invention can optionally include one or more other flame retardants in addition to the phosphinic acid metal salt flame retardant. Examples of other flame retardants include without limitation aromatic phosphoric acid ester-based compounds; nitrogen-containing compounds such as melamine, melamine cyanurate, and the like; nitrogen-phosphorus-containing compounds such as melamine pyrophosphate, melamine polyphosphate, and the like; and the like, and combinations thereof in addition to the phosphinic acid metal salt flame retardant.

The aromatic phosphoric acid ester-based compounds are not particularly limited. In exemplary embodiments, the aromatic phosphoric acid ester-based compound can be a compound represented by the following Chemical Formula 15.

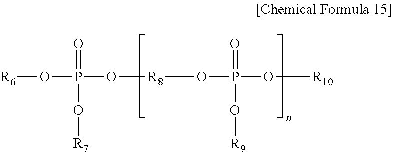

In the above Chemical Formula 15,

each R₆, R₇, R₉ and R₁₀ is the same or different and is independently C6 to C20 aryl or alkyl-substituted C6 to C20 aryl,

R₈ is derivative of a dialcohol comprising resorcinol, hydroquinone, bisphenol A, or bisphenol S, and

n is an integer ranging from 0 to 5.

The alkyl of the alkyl-substituted aryl may be a C1 to C14 alkyl.

Examples of the aromatic phosphoric acid ester-based compound, in which n is 0 in the above Chemical Formula 15, may include without limitation triphenylphosphate, tricresyl phosphate, cresyldiphenylphosphate, trixylyl phosphate, tri(2,4,6-trimethylphenyl)phosphate, tri(2,4-ditertiarybutylphenyl)phosphate, tri(2,6-ditertiarybutylphenyl)phosphate, and the like, and combinations thereof.

Examples of the aromatic phosphoric acid ester-based compound, in which n is 1 in the above Chemical Formula 15, may include without limitation resorcinol bis(diphenylphosphate), hydroquinone bis(diphenylphosphate), bisphenol A-bis(diphenylphosphate), resorcinol bis(2,6-ditertiarybutylphenylphosphate), hydroquinone bis(2,6-dimethylphenylphosphate), and the like, and combinations thereof.

The aromatic phosphoric acid ester-based compound, in which n is 2 or more in the above Chemical Formula 15, may exist as an oligomeric mixture.

According to one embodiment of the present invention, the aromatic phosphoric acid ester-based compound may include all aromatic phosphoric acid ester-based compounds in addition to the aforementioned materials. They can be used singularly or as a combination of two or more.

The aromatic phosphoric acid ester-based compound in the present invention may further include other phosphorus-containing flame retardants such as but not limited to phosphonates, phosphazenes, and the like, and combinations thereof.

The flame retardant thermoplastic resin composition can include the other flame retardants in an amount of 0 to about 30 parts by weight, based on the total weight of (A), (B), (C), (D), and (E). In some embodiments, the flame retardant thermoplastic resin composition may include the other flame retardants in an amount of 0 parts by weight (that is, the other flame retardants are not present), or about 0 (that is, an amount greater than zero), 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the other flame retardants can be in a range from about any of the foregoing amounts to about any other of the foregoing amounts.

The flame retardant thermoplastic resin composition can include the phosphinic acid metal salt compound in an amount of about 0.5 to about 30 wt % based on about 100 wt % (the total weight) of (A), (B), (C), (D), and (E). In some embodiments, the flame retardant thermoplastic resin composition may include the phosphinic acid metal salt compound (C) in an amount of about 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the phosphinic acid metal salt compound can be in a range from about any of the foregoing amounts to about any other of the foregoing amounts.

When the flame retardant thermoplastic resin composition includes the phosphinic acid metal salt compound in an amount within the above range, the composition can have excellent processability and reduced out-gas discharge upon injection molding.

(D) Zinc Compound

A zinc compound is included as a corrosion inhibitor in order to maintain inherent fluidity of the flame retardant composition and prevent corrosion of materials of polymer processing equipment such as injection molding machines.

A flame retardant including phosphinic acid degrades at a high temperature upon injection molding and discharges an out-gas. The out-gas is acidic so that the metal surface of an extruder, a mold, and the like can be corroded. The present invention can include the polyphenylene sulfide resin to decrease the amount of flame retardant, which in turn can reduce the amount of out-gas discharge. The zinc compound can also capture and remove the out-gas discharge. Including the zinc compound and polyphenylene sulfide resin can significantly improve corrosion inhibition of the extruder or the mold.

Examples of the zinc compound can include without limitation zinc stannate (Zn₂SNO₄), zinc carbonate (ZnCO₃), and the like, and combinations thereof. In exemplary embodiments, the zinc-compound can include zinc carbonate. When a polyphenylene sulfide resin is added to a polyamide resin, it may decrease the amount of flame retardant, which may reduce the amount of out-gas discharge to corrode the material of the extruder. This, however, can cause problems because the polyamide resin does not maintain physical properties such as its inherent fluidity. In contrast, when a zinc compound such as zinc stannate or zinc carbonate is added to a base resin including polyamide resin and polyphenylene sulfide resin, as compared to using only polyphenylene sulfide resin, the composition may maintain fluidity as well as inhibit corrosion on the surface of a metal such as metal surfaces in polymer processing equipment, such as extruders, molds, screws, and the like. Corrosion inhibition improvements resulting from the inclusion of the corrosion inhibitor may be measured by a corrosion test, wherein the corrosion test evaluates the corrosion based on the rate of weight loss of the extruder die plate (or other metal component) over a period of time.

The flame retardant thermoplastic resin composition can include the zinc compound as a corrosion inhibitor in an amount of about 0.01 to about 10 wt % based on about 100 wt % (the total weight) of (A), (B), (C), (D), and (E). In exemplary embodiments, the flame retardant thermoplastic resin composition can include zinc stannate in an amount of about 0.3 to about 2.0 wt %. In other exemplary embodiments, the flame retardant thermoplastic resin composition can include zinc carbonate in an amount of about 0.3 to about 8.0 wt %.

In some embodiments, the flame retardant thermoplastic resin composition may include the zinc compound (D) in an amount of about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, or 10 wt %. Further, according to some embodiments of the present invention, the amount of the zinc compound (D) can be in a range from about any of the foregoing amounts to about any other of the foregoing amounts.

If the zinc compound is used in an amount within the above range, it is possible to effectively inhibit corrosion of the surface of an extruder without negatively affecting physical properties (strength, fluidity and the like) of the polyamide resin. On the other hand, if the zinc compound is not added or is added in an excessive amount, corrosion of the metal plate may occur or fluidity may increase.

(E) Filler Including an Organic Filler, an Inorganic Filler, or a Combination Thereof.

The filler used in the present invention may be an organic filler, an inorganic filler, or a combination thereof. Examples of the organic filler include without limitation fibrous filler such as aramid fiber and the like. Examples of the inorganic filler include without limitation fibrous filler, such as carbon fiber, glass fiber, potassium titanate fiber, silicon carbide fiber, wollastonite and the like; and granular filler such as calcium carbonate, silica, titanium oxide, carbon black, alumina, lithium carbonate, iron oxide, molybdenum disulfide, graphite, glass beads, talc, clay, mica, zirconium oxide, silicic acid calcium, boron nitride, and the like, as well as combinations thereof.

The flame retardant thermoplastic resin composition can include the filler in an amount of about 0 to about 70 wt % based on about 100 wt % (the total weight) of (A), (B), (C), (D), and (E). In some embodiments, the flame retardant thermoplastic resin composition may include the filler (E) in an amount of 0 wt % (that is, the filler is not present), or about 0 (that is, an amount greater than zero), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of the filler (E) can be in a range from about any of the foregoing amounts to about any other of the foregoing amounts.

When the flame retardant thermoplastic resin composition includes filler in an amount within the above range, the composition may have excellent dimensional stability, heat resistance, and mechanical properties.

In an exemplary embodiment, the flame retardant thermoplastic resin composition may further comprise one or more additive(s). Exemplary additives include without limitation release agents, lubricants, compatibilizers, impact-reinforcing agents, plasticizers, nucleating agents, other flame retardants, colorants such as pigments or dyes, and the like, and combinations thereof, in addition to the aforementioned components, depending on various uses of the resin composition.

The flame retardant thermoplastic resin composition can be prepared using conventional resin manufacturing methods. For example, the flame retardant thermoplastic resin composition can be prepared into pellets by simultaneously mixing all components of the flame retardant thermoplastic resin composition of the present invention and other optional additives, and then fusion-molding the mixture in an extruder.

The flame retardant thermoplastic resin composition discharges little out-gas, and thus is good for extrusion and injection molding. The amount of discharged out-gas is about 0.1 to about 1.5 wt % when weight decrease of the composition is measured with TGA (thermogravimetric analysis) at 320° C. for 30 minutes. When the amount of discharged out-gas is over about 1.5 wt %, serious problems such as corrosion of the extruder and the mold may occur.

According to exemplary embodiments of the present invention, the flame retardant thermoplastic resin composition can be stable against fire (can be flame retardant) and can be environmentally friendly, since it does not include halogen-based flame retardants. In addition, when an aromatic polyamide resin is used, the composition can maintain excellent mechanical strength and heat resistance. When a polyphenylene sulfide resin having flame retardancy is used as a part of a mixed resin including the aromatic polyamide resin and the polyphenylene sulfide resin, the amount of a phosphinic acid metal salt flame retardant required as a flame retardant can be minimized. Accordingly, the composition of the present invention can maintain excellent heat resistance and flame retardancy and minimize mechanical strength deterioration and discharged out-gas. Further, by adding zinc compound as a corrosion inhibitor, the composition may effectively inhibit corrosion during processing, for example corrosion of the surface of the extruder, screw and the like, yet without lowering or decreasing fluidity and mechanical strength, as compared to a composition which includes only polyphenylene sulfide resin.

The flame retardant thermoplastic resin composition can be molded using various methods known in the art, such as injection molding, blow molding, extrusion molding, thermal molding, and the like.

Since the composition of the invention can have excellent heat resistance, mechanical strength, formability, a low moisture absorption rate, and environmentally friendly flame retardancy, it can be used for various electrical electronic parts or auto parts, for example for connectors and sockets, connector boxes, memories, brakes, and the like.

Hereinafter, the present invention is illustrated in more detail with reference to examples. However, these are exemplary embodiments of the present invention and are not limiting.

According to one embodiment of the present invention, the flame retardant thermoplastic resin composition includes the following components.

### EXAMPLES

Each component used in the preparation of the flame retardant thermoplastic resin composition in the present invention is as follows:

(A) Aromatic Polyamide Resin

A high-heat resisting modified nylon comprised benzene rings in a main chain polyhexamethylene adipamide/polyhexamethylene terephtalamide copolymer (PA66/6T: Mistui Ltd, C3200) is used as an aromatic polyamide resin.

(B) Polyphenylene Sulfide Resin

Polyphenylene sulfide made by Japanese DIC Inc. and having a melting index (MI) of 50 to 100 g/10 min at 316° C. under a weight of 2.16 kg is used.

(C) Phosphinic Acid Metal Salt Flame Retardant

Aluminum diethylphosphinate Exolit OP-1230 made by Clariant Ltd. is used as a phosphinic acid metal salt compound.

(D) Zinc Compound as a Corrosion Inhibitor
(D1) Zinc carbonate (ZnCO₃): Zinc carbonate made by Seido Chemical Industry Ltd is used.
(D2) (Zn₂SNO₄): Flamtard S made by William Blythe Ltd. is used.
(D3) Hydrotalcite: Pural MG70XD made by Sasol Ltd. is used.
(D4) MgO: STARMAG 150 made by Konoshima Chemical Ltd. is used.

(E) Organic Filler, Inorganic Filler or Combination Thereof.

Vetroex 910 made by Owens Corning Co. is used. The Vetroex 910 consists of glass fibers with a diameter of 10 μm and a chop length of 3 mm.

### Examples 1 to 4 and Comparative Examples 1 to 3

Resin compositions according to Examples 1 to 6 and Comparative Examples 1 to 5 are prepared using the aforementioned components as set forth in Tables 1 to 3.

The compositions are prepared by mixing each component in a common mixer according to the amounts set forth in Tables 1 below and putting the mixture in a twin-screw extruder (L/d=36, ¢=45 mm). The mixture is extruded through the twin-screw extruder to form resin composition into pellets. Then, specimens are prepared for property evaluation at a molding temperature 330° C. using a 10 oz molding machine.

Corrosion is evaluated based on weight loss of metal plate of die plate. SUS440C is used as the metal of the die plate. Corrosion based on weight loss rate of the die plate is evaluated after pressing out (extruding) for 8 hr at 30 kg/hr speed.

$$Weight loss ( \% ) = \text{?} \times 100$$

$$\text{?} \text{indicates text missing or illegible when filed}$$

Measurement of Properties

The specimens are allowed to stand at 23° C. under relative humidity of 50% for 48 hours, and the properties of each are then measured in accordance with ASTM standards.

For shaped specimens, notched and unnotched Izod impact strength (⅛″) is measured in accordance with ASTM D256.

Flexural modulus of the molded specimens is measured in accordance with ASTM D790 and tension strength is measured in accordance with ASTM D638.

Fluidity Index is measured according to ASTM D1238 at 330° C., 2.16 kg.

Flame retardancy specimens are measured at a thickness of 0.8 mm according to UL 94 VB flame retardancy standards.

TABLE 1

| | | | | | | | | Comp. | Comp. | Comp. | Comp. | Comp. |
|---|---|---|---|---|---|---|---|---|---|---|---|---|
| | | Ex. 1 | Ex. 2 | Ex. 3 | Ex. 4 | Ex. 5 | Ex. 6 | Ex. 1 | Ex. 2 | Ex. 3 | Ex. 4 | Ex. 5 |
| (A) Aromatic | | 56.7 | 56 | 41.5 | 42 | 44 | 51 | 41.5 | 56 | 56 | 42 | 47 |
| polyamide resin | | | | | | | | | | | | |
| (B) polyphenylene | | | | 10 | | 15.5 | 12 | 10 | | | 10 | |
| sulfide resin | | | | | | | | | | | | |
| (C) phosphinic acid | | 13 | 13 | 8 | 10 | 10 | 11 | 8 | 13 | 13 | 8 | 8 |
| metal salt compound | | | | | | | | | | | | |
| (D) | (D1) Zinc | 0.3 | 1.0 | 0.5 | 8 | | | | | | | 15 |
| Inorganic | carbonate | | | | | | | | | | | |
| compound | (D2) Zinc | | | | | 0.5 | 1.0 | | | | | |
| | stannate | | | | | | | | | | | |
| | (D3) | | | | | | | | | 1.0 | | |
| | Hydrotalcite | | | | | | | | | | | |
| | (D4) MgO | | | | | | | 0.5 | 1.0 | | | |

| | | | | | | | | | | | |
|---|---|---|---|---|---|---|---|---|---|---|---|
| (E) filler | 30 | 30 | 40 | 40 | 30 | 35 | 40 | 30 | 30 | 40 | 30 |
| Izod impact strength | 7.0 | 6.5 | 6.0 | 5.5 | 6.0 | 5.5 | 5.0 | 5.0 | 5.5 | 6.0 | 3.0 |
| (Notched) | | | | | | | | | | | |
| (kgf · cm/cm) | | | | | | | | | | | |
| Izod impact strength | 68 | 62 | 60 | 50 | 50 | 45 | 48 | 50 | 50 | 60 | 30 |
| (Unnotched) | | | | | | | | | | | |
| (kgf · cm/cm) | | | | | | | | | | | |
| Flexural strength | 2000 | 2000 | 2200 | 1900 | 1900 | 1800 | 1900 | 1800 | 1800 | 2200 | 1200 |
| (kgf/cm²) | | | | | | | | | | | |
| Tension strength | 1600 | 1600 | 1700 | 1600 | 1500 | 1500 | 1500 | 1500 | 1500 | 1700 | 1000 |
| (kgf/cm²) | | | | | | | | | | | |
| Fluidity index (g/min) | 50 | 55 | 55 | 70 | 65 | 70 | 90 | 110 | 100 | 50 | 120 |
| UL 94 (0.8 mm) | V-0 | V-0 | V-0 | V-0 | V-0 | V-0 | V-0 | V-0 | V-0 | V-0 | V-1 |
| Weight loss of metal | 0.15 | 0.1 | 0.15 | 0.15 | 0.2 | 0.1 | 2.0 | 2.0 | 2.0 | 5.0 | 1.0 |
| plate (%) | | | | | | | | | | | |

Referring to Comparative Example No. 1 to No. 6 in Table 1, by adding the zinc carbonate compound or the zinc stannate compound, the composition maintains mechanical properties such as fluidity and strength while the weight loss rate of an extruder metal plate is significantly improved (ranging from 0.1 to 0.2% for Examples 1-6) as compared to the composition of the comparative examples and corrosion rarely occurred.

Referring to Comparative Example No. 1 to No. 3 in Table 1, by including magnesium oxide or hydrotalcite instead of a zinc compound as an inorganic compound, mechanical strength of the composition decreases and the fluidity is not maintained but increases. With regard to the corrosion test, the weight loss rate is significantly increased and the effect of the corrosion inhibition did not improve as compared to the compositions of examples 1-6.

Referring to Comparative Example No. 4 in Table 1, by not adding the zinc compound, the fluidity of the composition is maintained, however, the weight loss rate of the metal plate is significantly increased.

Referring to Comparative Example No. 5 in Table 1, by adding an excessive amount of the zinc compound, the composition may have the corrosion inhibitor effect, however, the fluidity is significantly increased.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A flame retardant thermoplastic resin composition comprising:
(A) about 20 to about 99.49 wt % of an aromatic polyamide resin;
(B) about 0 to about 50 wt % of a polyphenylene sulfide resin;
(C) about 0.5 to about 30 wt % of a phosphinic acid metal salt flame retardant;
(D) about 0.01 to about 10 wt % of a zinc compound; and
(E) about 0 to about 70 wt % of a filler comprising an organic filler, an inorganic filler or a combination thereof.

2. The flame retardant thermoplastic resin composition of claim 1, wherein said zinc compound is zinc carbonate compound or zinc stannate compound.

3. The flame retardant thermoplastic resin composition of claim 2, comprising said zinc carbonate compound in an amount of about 0.3 to about 8.0 wt %.

4. The flame retardant thermoplastic resin composition of claim 2, comprising said zinc stannate compound in an amount of about 0.3 to about 2.0 wt %.

5. The flame retardant thermoplastic resin of claim 1, wherein said aromatic polyamide resin (A) has benzene rings in a main chain and has a melting point of about 180° C. or more.

6. The flame retardant thermoplastic resin of claim 1, wherein said phosphinic acid metal salt compound (C) comprises aluminum diethylphosphinate, aluminum methylethylphosphinate or a combination thereof.

7. The flame retardant thermoplastic resin of claim 1, wherein said organic filler is an aramid fiber, and wherein said inorganic filler is a fibrous filler comprising carbon fiber, glass fiber, potassium titanate fiber, silicon carbide fiber or wollastonite, or a granular filler comprising calcium carbonate, silica, titanium oxide, carbon black, alumina, lithium carbonate, iron oxide, molybdenum disulfide, graphite, glass beads, talc, clay, mica, zirconium oxide, calcium silicate, or boron nitride, or a combination thereof.

8. The flame retardant thermoplastic resin of claim 1, further comprising an additive comprising a release agent, a lubricant, a compatibilizer, an impact-reinforcing agent, a plasticizer, a nucleating agent, a colorant, or a combination thereof.

9. A molded product made using the flame retardant thermoplastic resin composition according to claim 1.
